(19) United States
(12) Patent Application Publication
(10) Pub. No.: US 2017/0316724 A1
(43) Pub. Date: Nov. 2, 2017

(54) MAGNETIC FLUID COMPOSITE FOR DISPLAY USE, AND MAGNETIC FLUID COMPOSITE DISPLAY DEVICE

(71) Applicant: SHIGMA HI-CHEMICAL INC., Fujisawa-shi, Kanagawa (JP)

(72) Inventors: Hideo OHNO, Kanagawa (JP); Daiki INAMURA, Kanagawa (JP)

(73) Assignee: SHIGMA HI-CHEMICAL INC., Fujisawa-shi, Kanagawa (JP)

(21) Appl. No.: 15/504,759

(22) PCT Filed: May 14, 2015
(86) PCT No.: PCT/JP2015/064547

§ 371 Date: Jun. 6, 2017

(30) Foreign Application Priority Data
Aug. 19, 2014 (JP) 2014-166577

(51) Int. Cl. G09F 19/02; H01F 1/34; A63H 33/26; H01F 7/02; A63H 33/22

(52) U.S. Cl. CPC G09F 19/02; H01F 7/0231; A63H 33/22; A63H 33/26; H01F 1/34

(57) ABSTRACT

Provided are a magnetic fluid composite for display use which enables visually recognizing a subtle shape caused by a spiking phenomenon and which can exhibit a color other than black, and a magnetic fluid composite display device.

A magnetic fluid composite 1 for display use contains water 10, an oily magnetic fluid 20 and poorly magnetic light shielding pieces 30.

The light shielding pieces 30 have a flake shape and include respectively hydrophilic layers 31, light shielding layers 33 and hydrophilic layers 35 that are laminated in the written order.

The light shielding pieces 30 are arranged along the interface 1i between the water 10 and the oily magnetic fluid 20 so that the interface 1i between the water 10 and the oily magnetic fluid 20 is covered with a number of the light shielding pieces 30.

A magnetic fluid composite display device 2 includes a transparent container 40 including a glass container main body 41 and a resin lid 42, a magnetic fluid composite 1 placed inside the container, and a permanent magnet 50 configured to apply a magnetic force to the magnetic fluid composite 1.

### TECHNICAL FIELD

The present invention relates to a magnetic fluid composite for display use, and a magnetic fluid composite display device. In more detail, the present invention relates to a magnetic fluid composite for display use which enables displaying various shapes of magnetic fluid caused by a spiking phenomenon in a suitable manner for observation and appreciation, and a magnetic fluid composite display device using the same.

### BACKGROUND ART

A spiking phenomenon as described below has been known as an interface phenomenon of magnetic fluid.

That is, when magnetic fluid is attracted to a magnet to cause a minute agitation in the interface, the intensity of the magnetic field changes accordingly, and the magnetic field lines concentrate relatively to the vertices of a wave surface.

An increase of the magnetic force causes increased magnetization in vertices and reduced magnetization in bottoms, which further causes deformation to a position in which the magnetic pressure, the gravity and the surface tension balance out. Eventually, the magnetic fluid is formed into regularly arranged regular hexagonal pyramids (spikes) and becomes stable in this shape (e.g. see Non-Patent Document 1).

In particular, when oily magnetic fluid is placed in water, the spiking phenomenon is more noticeable than in the air and produces a higher effect of visual appreciation. Therefore, showpieces using magnetic fluid in this combination have been widely produced.

### CITATION LIST

### Non-Patent Document

Non-Patent Document 1: “Introduction to Magnetic Fluid”, p. 75, Shin-ichi Kamiyama, Sangyo Tosho, 1989

### SUMMARY OF INVENTION

### Technical Problem

However, since magnetic fluid is liquid in which ultrafine particles of ferrite such as magnetite are dispersed in carrier liquid at high concentration, it has a jet black color and absorbs almost all visible light. Accordingly, magnetic fluid does not have contrast even under an intense illumination, and it has therefore been difficult to visually recognize a subtle shape thereof.

It is possible to mix magnetic fluid with a dye or a pigment to colorize it so as to increase the visibility of the magnetic fluid. However, this is not suitable because sufficient coloring for visual recognition and appreciation results in significant degradation of the magnetic properties.

The present invention has been made in view of the above-described problem with the prior art, and an object thereof is to provide a magnetic fluid composite for display use which enables visual recognition of a subtle shape caused by the spiking phenomenon and which can exhibit a color other than black, and a magnetic fluid composite display device.

### Solution to Problem

As a result of a keen study for achieving the above-described object, the present inventors have found that when predetermined poorly magnetic light shielding pieces are added, they are arranged in the interface between water and oily magnetic fluid, and the above-describe object is thereby achieved. The present invention has been thus completed.

That is, the magnetic fluid composite for display use of the present invention contains water, an oily magnetic fluid and poorly magnetic light shielding pieces having hydrophilic portions.

Further, the magnetic fluid composite display device of the present invention is a display device for a magnetic fluid composite utilizing the spiking phenomenon of magnetic fluid, which includes:
the above-described magnetic fluid composite for display use; a container having an observation part through which the inside is observable; and a magnetic field generating member,
wherein the magnetic field generating member is configured to apply a magnetic force to the magnetic fluid composite for display use placed in the container.

### Advantageous Effects of Invention

According to the present invention, the predetermined poorly magnetic light shielding pieces are used. Therefore, it is possible to provide a magnetic fluid composite for display use which enables visual recognition of a subtle shape caused by the spiking phenomenon and which can exhibit a color other than black, and a magnetic fluid composite display device.

### BRIEF DESCRIPTION OF DRAWINGS

FIG. 1 is a partial enlarged cross sectional view schematically illustrating a part of a magnetic fluid composite for display use according to an embodiment of the present invention.

FIG. 2 is a partial enlarged cross sectional view schematically illustrating a part of a magnetic fluid composite for display use when the spiking phenomenon occurs.

FIG. 3 is a schematic cross sectional view of a magnetic fluid composite display device is according to an embodiment of the present invention.

FIG. 4 is a photograph of a magnetic fluid composite for display use of the present invention that forms spikes.

FIG. 5 is a photograph of a magnetic fluid composite for display use of the present invention that forms spikes.

### DESCRIPTION OF EMBODIMENTS

Magnetic Fluid Composite

Hereinafter, the magnetic fluid composite for display use of the present invention will be described referring to the drawings.

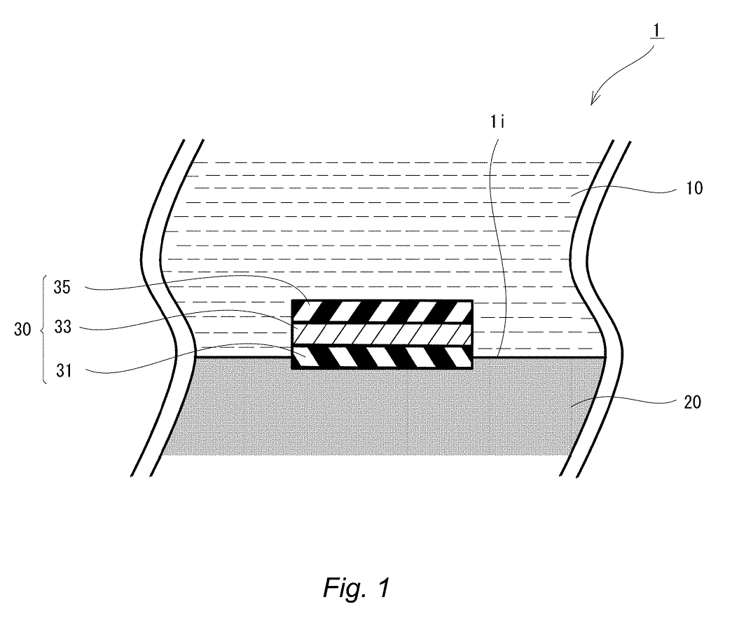

FIG. 1 is a partial enlarged cross sectional view schematically illustrating a part of a magnetic fluid composite for display use according to an embodiment of the present invention.

In the figure, the magnetic fluid composite 1 for display use, which is a composite of a magnetic fluid, water and other materials, includes water 10, an oily magnetic fluid 20 and poorly magnetic light shielding pieces 30. The light shielding pieces 30, which have a flake shape, include respectively hydrophilic layers 31, light shielding layers 33 and hydrophilic layers 35 that are laminated in the written order.

In the embodiment, the hydrophilic layers 31 and the hydrophilic layers 35 function as hydrophilic portions, and both layers have the same hydrophilicity.

The degree of the hydrophilicity of the layers may he suitably changed according to the type of dispersion medium of the oily magnetic fluid 20 used, and the layers may be so-called ultrahydrophilic, which refers to having a water contact angle of 10° or less. Meanwhile, a certain degree of affinity to oil is also required. The required degree of affinity to oil is such that the poorly magnetic light shielding pieces 30 can contact the oily magnetic fluid body 20 to form a stable interface at least temporarily, and that they are not incorporated into the oily magnetic fluid 20.

In the magnetic fluid composite 1, the light shielding pieces 30 are arranged along the interface 1i between the water 10 and the oily magnetic fluid 20, in which one of the hydrophilic layers 31 and hydrophilic layers 35 is oriented to the water 10 while the other is oriented to the oily magnetic fluid 20.

FIG. 1 illustrates a representative state in which the hydrophilic layer 35 is oriented to the water 10 and the hydrophilic layer 31 is oriented to the oily magnetic fluid 20.

It is not always essential to provide both of the hydrophilic layers 31 and the hydrophilic layers 35. When the light shielding layers 33 have the same hydrophilicity and affinity to oil as the hydrophilic layers, the light shielding pieces 30 can be arranged as described above by providing only one of the hydrophilic layers by means of the affinity of the provided hydrophilic layers to the water 10.

As described above, the magnetic fluid composite 1 is in a state as if the interface 1i between the water 10 and the oily magnetic fluid 20 is covered with a number of light shielding pieces 30.

Accordingly, in the magnetic fluid composite 1, visible light that is incident to the oily magnetic fluid 20 through the water 10 is interrupted by the light shielding layers 33 of the light shielding pieces 30 so that the viewer does not visually recognize the color (normally black due to ferrite) of the oily magnetic fluid 20 but can visually recognize only the color of the light shielding pieces 30, typically the color of the light shielding layers 33.

In this regard, when the light shielding pieces 30, typically the light shielding layers 33, are constituted by metal coating or the like having high light reflectivity, the light shielding pieces 30 exhibit very good visibility and the viewer can therefore visually recognize the definite overall shape of the interface 1i by means of the reflection light from the light shielding pieces 30.

With the above-described configuration of the magnetic fluid composite, the predetermined light shielding pieces 30 are arranged along the interface 1i to cover the entire interface so as to hide the color of the oily magnetic fluid 20 as well as to clarify the overall shape of the interface 1i. This phenomenon was found by the present inventors.

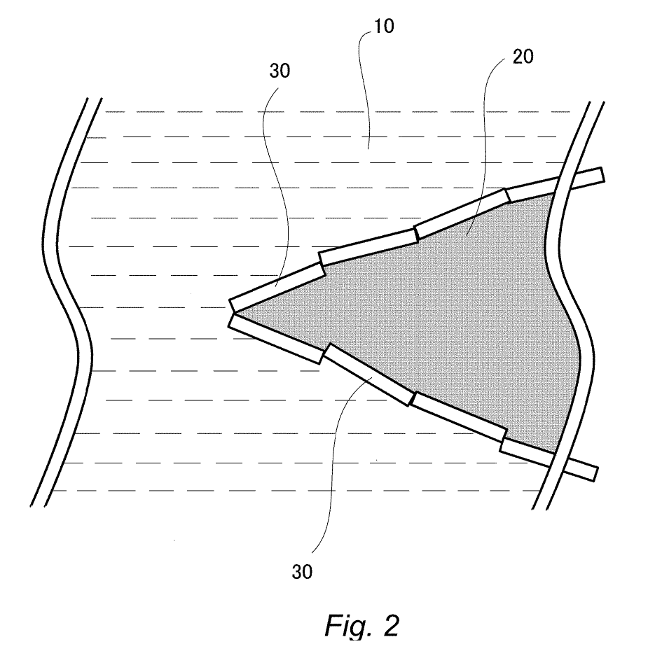

Further, since the light shielding pieces 30 have both the hydrophilicity and the affinity to oil as a whole as described above and exhibit good orientation of the hydrophilic layers 35, 31, they can quickly follow a change of the shape of the interface 1i caused by the spiking phenomenon or the like (see FIG. 2). This feature was also found by the present inventors.

Since the light shielding pieces 30 are poorly magnetic, i.e., does not have a ferromagnetic property, there is little negative influence on the above-described properties of orientation, arrangement and shape-following even when they are disposed in a magnetic field.

Next, the components of the magnetic fluid composite of the present invention will be described.

First, the water may be ordinary water, and tap water, ion-exchanged water, so-called pure water or the like can be used.

The oily magnetic fluid may be one of those known in the art.

Typical oily magnetic fluid is configured such that ferritic magnetic particles such as Fe ferrite (i.e. magnetite), Mn ferrite, Co ferrite, Ni ferrite, Zn ferrite, Mn—Co ferrite, Mo—Ni ferrite and Mo—Zn ferrite particles are finely dispersed in oily dispersion medium such as kerosene in the presence of a surfactant such as oleic acid.

The poorly magnetic light shielding pieces with hydrophilic portions and the affinity to oil may be constituted by any micro thin film pieces that have hydrophilicity, the above-described affinity to oil, the poorly magnetic property and the light shielding property. While they may also be constituted by metal flakes, representative examples include micro thin resin films on which poorly magnetic metal coating is provided by vapor deposition and which are further subjected to a hydrophilic treatment with a surfactant or the like, similar resin films on which poorly magnetic metal coating is provided by vapor deposition, which are thereafter coated with an epoxy resin or the like and which are further subjected to a discharge treatment, and the like.

In addition to such resin film-based ones, the poorly magnetic light shielding pieces may also be based on a micro inorganic plate-like material such as glass or mica. Further, the light shielding layers may also be constituted by metal oxide coating such as titanium oxide (TiO₂) and alumina (Al₂O₃) as well as the above-described metal coating.

Examples of resins of the resin films include thermoplastic resins known in the art, of which nylon, polyimide, polycarbonate, ethylene-vinyl acetate copolymer (EVA), ethylene-methacrylate copolymer (EMMA) and polyethylene terephthalate can be suitably used.

Examples of metals of the metal coating include poorly magnetic metals, such as aluminum (Al), silver (Ag), zinc (Zn), gold (Ag) and copper (Cu).

Representative examples of the light shielding pieces include cosmetic gloss materials that are commercially available as glitter materials. Glitter materials are produced by depositing a metal such as aluminum on a plastic film of polyethylene terephthalate or the like by vapor deposition and thereafter finely cutting it into pieces, and such glitter materials that are further subjected to a hydrophilic treatment can be used as the light shielding pieces.

When a glitter material is added to a mixture of water and oily magnetic fluid without any treatment, it selectively wets only with the magnetic fluid due to its highly lipophilic plastic surface and is therefore incorporated into the magnetic fluid. As a result, it is not possible to achieve the above-described arrangement along the interface and the resultant visual effect.

Materials called metallic powders, which are produced by depositing a metal such as aluminum on a colored or non-colored resin film by vapor deposition, further coating it with the same resin film to obtain a laminated film and freeze-drying the laminated film, can also be used similarly with glitter materials.

Regarding the hydrophilicity, it is preferred that the light shielding pieces have such hydrophilicity that the contact angle between the hydrophilic portions such as the hydrophilic layers and water is equal to or less than 15°. When the angle is greater than 15°, the light shielding pieces may be incorporated into the oily magnetic fluid. To adjust the hydrophilicity of the light shielding pieces, an actual preliminary test may be conducted regarding whether the light shielding pieces are arranged along the interface between water and the oily magnetic fluid used without being incorporated into the oily magnetic fluid. The hydrophilic treatment for this purpose may be a surfactant or discharge treatment as described above.

The shape, size and thickness of the light shielding pieces may be suitably changed according to the type of the oily magnetic fluid used and the intended display characteristics. While they may have a triangular, polygonal, circular or oval shape, a representative shape is a rectangular or square shape of 0.01-2 mm×0.01-2 mm with a thickness of 0.5-50 μm.

Outside these numeral ranges, a desired display effect may not be obtained.

The light shielding pieces may also have an indefinite shape, which is obtained, for example, by finely grinding a glass thin plate.

Magnetic Fluid Composite Display Device

Next, the magnetic fluid composite display device of the present invention will be described in detail referring to the drawings.

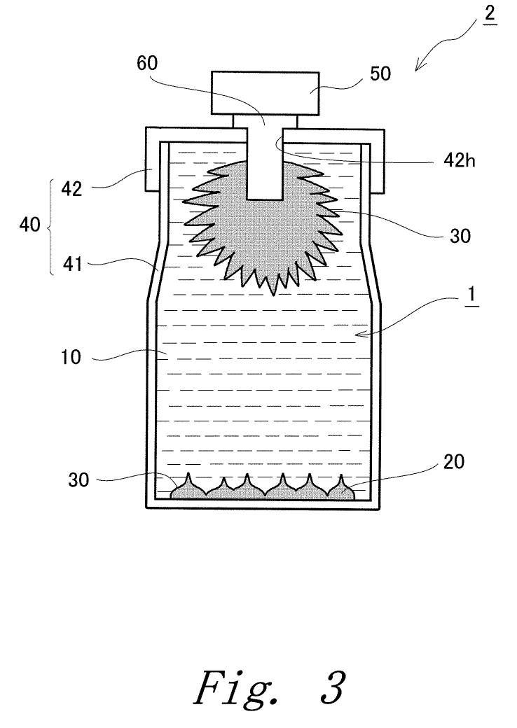

FIG. 3 is a schematic cross sectional view of a magnetic fluid composite display device according to an embodiment of the present invention.

The same reference signs are denoted to the members and components that are practically the same as the above-described members and components, and the description thereof is omitted.

In FIG. 3, the magnetic fluid composite display device 2, which is a display device that utilizes the spiking phenomenon of the magnetic fluid of the above-described magnetic fluid composite for display use, includes a transparent container 40 including a glass container main body 41 and a resin lid 42, the magnetic fluid composite 1 placed therein, and a permanent magnet 50 which is an example of a magnetic field generating member for applying a magnetic force to the magnetic fluid composite 1.

A hole 42h is formed in the lid 42 of the transparent container 40, and a collector member, which is a ferromagnetic steel having a rivet shape, protrudes into the transparent container 40 through the hole 42.

In the display device 2 with the above-described configuration, when a magnetic force is applied to the magnetic fluid composite 1 by means of the permanent magnet 50, the oily magnetic fluid 20 and the light shielding pieces 30 laid on the bottom of the container 40 move (rise) toward the permanent magnet 50 disposed near the head of the container 40 while causing the spiking phenomenon, and then adhere to the collector member 60 to form a unique shape (see FIG. 3).

Conventionally, the shape of oily magnetic fluid in water, which is jet black liquid mutually insoluble to water, was able to be watched only in a poorly visible state. However, with the present invention, it is possible to clearly and visually recognize the shape of oily magnetic fluid due to the light shielding pieces arranged along the interface as described above.

The specific gravity of the oil-soluble magnetic fluid is arbitrary changeable by changing the ferrite concentration. Accordingly, it is possible to achieve three different states of the magnetic fluid, floating on water, suspending in water and lying on the bottom of water.

The present invention is applicable to a composite that includes oily magnetic fluid in any state.

In the embodiment in FIG. 3, the magnetic fluid composite can be observed from almost all directions of the container since the transparent container 40 is used.

Instead, a container that has an observation window in a part may also be used.

The collector member 60 is constituted by a steel member having a rivet shape.

Instead, it may also be made of any ferromagnetic material other than steel, so long as it can conduct the magnetic force from the permanent magnet 50. Further, a variety of shapes such as conical, dumbbell, cross, spherical, elliptic spherical and star shapes may also be employed instead of the pillar shape, and the magnetic fluid attached thereto takes a variety of shapes accordingly. Therefore, it is possible to improve the ornamental value

The collector member is not essential. When the composite is small, it is possible to achieve a sufficient change of the shape without any collector member.

A plurality of collector members 60 or a plurality of permanent magnets 50 can be disposed, which enables changing attached shape of the magnetic fluid accordingly. A permanent magnet is used as an example of the magnetic field generating member. However, it is needless to say that an electromagnet may also be used instead, which can be combined with a magnetic force controlling member such as an electric current controlling member in order to switch the magnetic force applied to the magnetic fluid composite between on and off or to change it periodically or randomly. Since the shape of the magnetic fluid is changed accordingly, this can improve the ornamental value.

### EXAMPLE

Hereinafter, the present invention will be described in more detail with examples and comparative examples. However, the present invention is not limited thereto.

### Example 1

Aluminum is deposited on a polyethylene terephthalate film (20 μm thick) by vapor deposition, and the film is thereafter coated by an epoxy resin.

The film A thus obtained was measured for the water contact angle. It was 70°. Next, the film A was processed with a high-frequency corona treatment equipment so that a film B was obtained.

The film B was measured for the water contact angle as described above. It was 10°.

The film B thus obtained was cut into squares of 0.5 mm×0.5 mm, and 0.2 g of the film was added into a glass container in which 10 ml of oily magnetic fluid (magnetite ultrafine particles dispersed in isoparaffin having a boiling point within the range of 200° C. to 250° C., specific gravity of 1.05) and 90 ml of pure water were previously charged. The cut film sank into water. The mixture was then gently stirred, and the cut film adsorbed to the interface between the magnetic fluid and the pure water but was not incorporated into the magnetic fluid.

A magnet was brought to the vicinity so that spikes are formed. It was observed that the cut film followed the deformation of the magnetic fluid to cover the entire interface, and the spikes exhibited metallic luster.

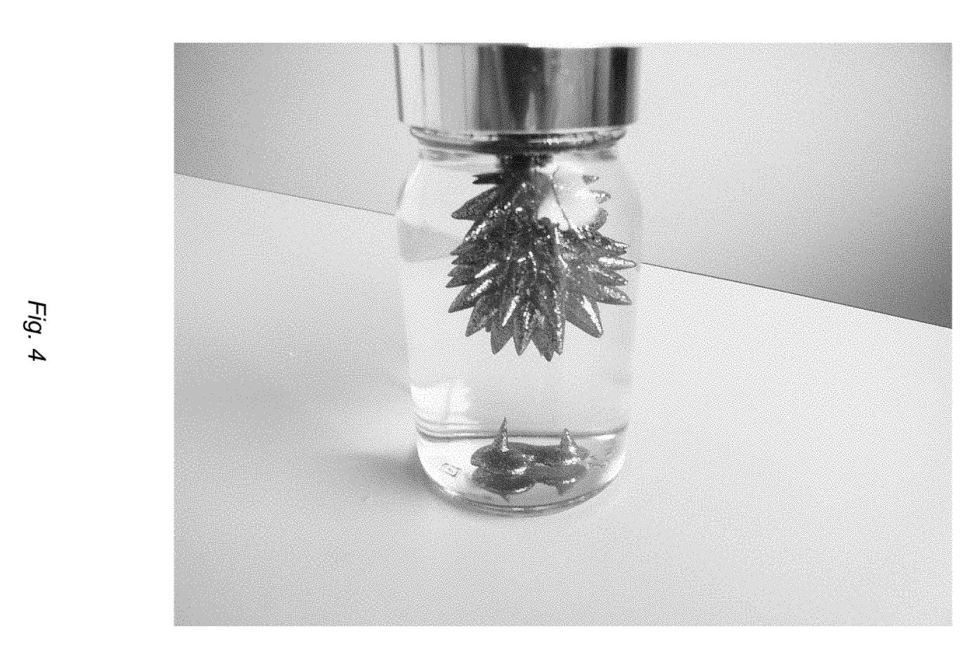

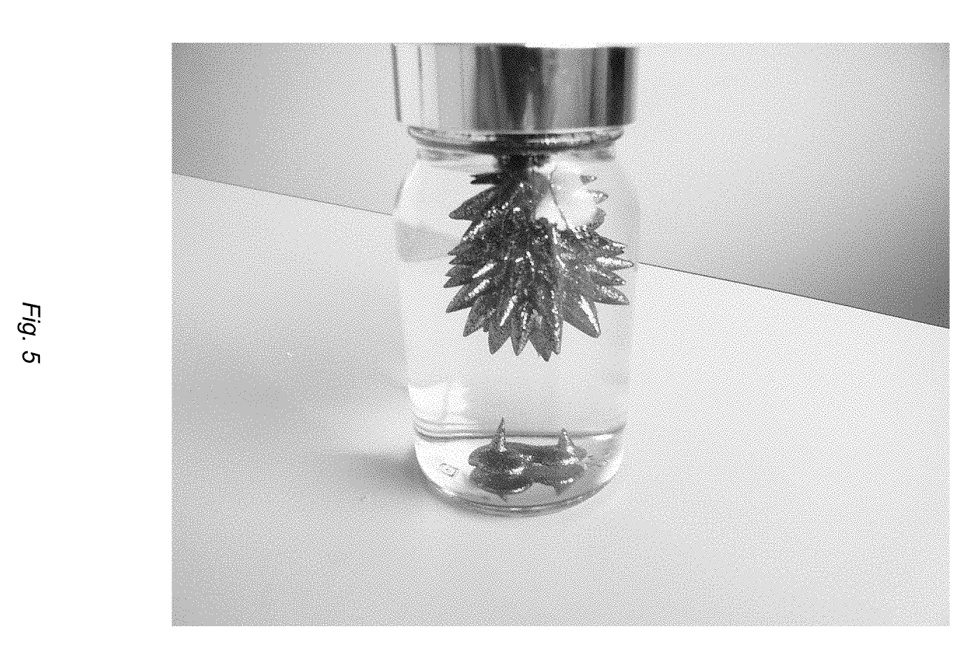

This was illustrated in FIG. 4 and FIG. 5.

### Comparative Example 1

The film A of Example 1 was cut in the same manner as above, and 0.2 g of the film was added into a glass container in which 10 ml of the oily magnetic fluid and 90 ml of pure water were previously charged. The cut film floated on the water surface and did not sink.

To bring the cut film into contact with the magnetic fluid, the container is closed and the mixture was stirred by inversion. All of the cut film was incorporated into the magnetic fluid and became visually unrecognizable.

### Example 2

Solution of 1 g of ultrahydrophilic coating agent (LAMBIC-500WP, Osaka Organic Chemical Industry Ltd.) in 100 g of pure water was poured into a vat, and the film A of Example 1 was soaked therein.

Then, the vat was placed in a dryer maintained at 105° C. so that the water was completely evaporated.

After allowing it to cool to room temperature, a film C thus obtained was measured for the water contact angle. It was 5°.

The film was cut into 0.1 mm×0.1 mm, and 0.2 g of the film was added into the container with the magnetic fluid and water and gently stirred in the same manner as described in Example 1. The cut film adsorbed to the interface between the magnetic fluid and pure water and was not incorporated into the magnetic fluid.

A magnet was brought to the vicinity so that spikes are formed. It was observed that the cut film followed the deformation of the magnetic fluid to cover the entire interface, and the spikes exhibited metallic luster.

### Example 3

An ultrahydrophilic coated film (film D) was obtained in the same manner as Example 2 except that the ultrahydrophilic coating agent solution was replaced with the 10-fold diluted solution thereof in pure water.

The film D was measured for the water contact angle. It was 15°. In the same manner as Example 2, the cut film was added to the magnetic fluid and pure water in a container, and the mixture was gently stirred. A large part of the film adsorbed to the interface between the magnetic fluid and water, but the remaining part was incorporated into the magnetic fluid. As a result, the visual effect was rather poor.

### Example 4

A commercially available glitter material (reddish gold glitter φ0.1, Fujikura Ohyo-Kako Co., Ltd.) (0.2 g) was added to 10 ml of the ultraphydrophilic coating agent solution prepared in Example 2, and the water was completely evaporated in a dryer maintained at 105° C. After allowing it to cool to room temperature, all of the glitter material was added to the magnetic fluid and water in a glass container that were prepared in the same manner as Example 1. The glitter material sank into water. By gently stirring the mixture, the glitter material adsorbed to the interface between the magnetic fluid and water.

A magnet was brought to the vicinity from the bottom of the container so that spikes are formed. It was observed the entire spikes exhibited gold luster.

While the present invention was described with a few embodiments and examples, the present invention is not limited to these embodiments and examples, and various changes can be made within the feature of the present invention.

For example, regarding the light shielding pieces 30, it is not necessary to provide the hydrophilic portions to the entire surfaces as long as the light shielding pieces are not incorporated into the oily magnetic fluid. The hydrophilic portions may be provided only in either front or back faces or in a part of either front or back faces.

While an example in which the light shielding pieces are based on a resin film is illustrated, a metal thin film itself can be used as the light shielding pieces as long as it has light shielding property and hydrophilicity that can prevent the light shielding pieces from being incorporated into the oily magnetic fluid.

It is not necessary that the hydrophilic layers 31, 35 of the light shielding pieces 30 have the same degree of hydrophilicity, but they may have different degrees of hydrophilicity. With different degrees of hydrophilicity, it is possible to preferentially orient the layers with higher degree of hydrophilicity to the water 10.

### INDUSTRIAL APPLICABILITY

The magnetic fluid composite for display use and the magnetic fluid composite display device of the present invention are not only suitably used in toy industry but also applicable to a variety of display devices, display apparatuses and the like.

### REFERENCE SIGNS LIST

1 Magnetic fluid composite for display use
1s Interface
2 Magnetic fluid composite display device
10 Water
20 Oily magnetic fluid
30 Light shielding piece
31 Hydrophilic layer
33 Light shielding layer
35 Hydrophilic layer
40 Transparent container
41 Container main body
42 Lid
42h Hole
50 Permanent magnet
60 Collector member

1. A magnetic fluid composite for display use, containing: water; an oily magnetic fluid; and poorly magnetic light shielding pieces comprising respective hydrophilic portions.

2. The magnetic fluid composite for display use according to claim 1, wherein the hydrophilic portions of the poorly magnetic light shielding pieces have a water contact angle of 15° or less.

3. The magnetic fluid composite display device using a spiking phenomenon of magnetic fluid, comprising: the magnetic fluid composite for display use according to claim 1; a container comprising an observation part through which an inside is observable; and a magnetic field generating member,
wherein the magnetic field generating member is configured to apply a magnetic force to the magnetic fluid composite for display use placed in the container.

4. The magnetic fluid composite display device using a spiking phenomenon of magnetic fluid, comprising: the magnetic fluid composite for display use according to claim 2;
a container comprising an observation part through which an inside is observable; and a magnetic field generating member,
wherein the magnetic field generating member is configured to apply a magnetic force to the magnetic fluid composite for display use placed in the container.
